(19) United States
(12) Patent Application Publication
(10) Pub. No.: US 2008/0319871 A1
(43) Pub. Date: Dec. 25, 2008

(54) Systems and Methods for Auto-Generation of Rich Media Purchase, Reservation and/or Activity Information

(76) Inventors: Rowland Hayes Thomas, Sunny Isles Beach, FL (US); Isaac D. Wieder, Sunny Isles Beach, FL (US)

Correspondence Address: BIRCH STEWART KOLASCH & BIRCH, PO BOX 747, FALLS CHURCH, VA, 22040-0747, US

(21) Appl. No.: 12/146,260

(22) Filed: Jun. 25, 2008

Related U.S. Application Data
(60) Provisional application No. 60/929,377, filed on Jun. 25, 2007.

(51) Int. Cl. G06Q 30/00

(52) U.S. Cl. 705/26

(57) ABSTRACT

Systems, methods, apparatus and computer-readable mediums as discussed herein provide for a method for generating a dynamic electronic book for display in a multimedia player application including receiving information about a purchase by a consumer from a first remote computing device; accessing content associated with the received information; extracting characteristic data associated with the purchase from the received data; selecting content to be included in the electronic book from the accessed content based on the characteristic data; generating a dynamic configuration file including information identifying the selected content, information identifying at least one template page, and at least a portion of the received information; transmitting the generated dynamic configuration file to a remote device; receiving a request for content and the at least one template page identified in the dynamic configuration file; transmitting the content and the at least one template page in response to the request for display in the electronic book.

### RELATED APPLICATIONS

This application is related to and claims priority to U.S. Provisional Application No. 60/929,377 filed on Jun. 25, 2007, entitled “SYSTEMS AND METHODS FOR AUTO-GENERATION OF RICH MEDIA RESERVATION AND/OR RESORT ACTIVITY INFORMATION”, which is expressly incorporated herein by reference in its entirety.

### BACKGROUND OF THE INVENTION

1. Field of the Invention

The invention relates generally to network applications and more specifically, to systems and methods of displaying services or items purchased or potentially purchased.

2. Description of Related Art

With the increase of commerce over the Internet, consumers are increasingly using the Internet to view items they wish to purchase, reserved, or have purchased in the past. Currently the method of reviewing a purchase, reservation, or potential purchase is through a static web page or email. As such, when a consumer makes or is looking to make a purchase, the consumer is not likely to seriously consider additional information available regarding the service or item purchased. As such, not all available information is taken advantage of.

As such, there is a need for a system and method that optimizes the way a consumer views information about an item or service they purchased or are considering in a rich and enticing manner.

### SUMMARY OF THE INVENTION

Systems, methods, apparatus and computer-readable mediums as discussed herein provide for a method for generating a dynamic electronic book for display in a multimedia player application, comprising receiving information about a purchase by a consumer from a first remote computing device; accessing content associated with the received information; extracting characteristic data associated with the purchase from the received data; selecting content to be included in the electronic book from the accessed content based on the characteristic data; generating a dynamic configuration file including information identifying the selected content, information identifying at least one template page, and at least a portion of the received information; transmitting the generated dynamic configuration file to a remote device; receiving a request for content and the at least one template page identified in the dynamic configuration file; transmitting the content and the at least one template page in response to the request for display in the electronic book.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 is an exemplary system environment for implementing the features consistent with some embodiments of the present invention;

FIG. 2 is an exemplary block diagram of the components of a client computer, consistent with principles of some embodiments of the present invention;

FIG. 3 is an exemplary block diagram of the components of computing devices, consistent with principles of some embodiments of the present invention;

FIG. 4 depicts an exemplary block diagram of the components of computing devices, consistent with principles of some embodiments of the present invention;

FIG. 4A depicts an exemplary block diagram of the components included in application software, consistent with the principles of some embodiments of the present invention;

FIGS. 5-5A depicts an exemplary flow diagram of the steps performed by the devices operating within the system environment, consistent with the principles of some embodiments of the present invention; and

FIGS. 6A-6G depict exemplary screen displays presented to a consumer, consistent with the principles of some embodiments of the present invention;

### DETAILED DESCRIPTION

Reference will now be made in detail to the features of the principles of the present invention, examples of which are illustrated in the accompanying drawings. Wherever possible, the same reference numbers will be used throughout the drawings to refer to the same or like parts.

Systems, methods and computer-readable mediums consistent with the principles of some embodiments of the present invention provide for a method for generating a dynamic electronic book for display in a multimedia player application, comprising receiving information about a purchase by a consumer from a first remote computing device; accessing content associated with the received information; extracting characteristic data associated with the purchase from the received data; selecting content to be included in the electronic book from the accessed content based on the characteristic data; generating a dynamic configuration file including information identifying the selected content, information identifying at least one template page, and at least a portion of the received information; transmitting the generated dynamic configuration file to a remote device; receiving a request for content and the at least one template page identified in the dynamic configuration file; and transmitting the content and the at least one template page in response to the request for display in the electronic book.

Alternatively, systems and methods consistent with principles of some embodiments of the present invention provide for generating dynamic configurations of information displayed in a multimedia player including providing for content to be included in the dynamic configuration; establishing characteristic information for determining content; establishing a location where the content for the multimedia player can be retrieved and viewed; integrating with a third party application to retrieve data regarding a about a new, past, future or potential purchase that should be communicated to a consumer; retrieving information about the consumer that made a new, past, future or potential purchase and combining it with the information transmitted from the third party system to create characteristic data; generating a dynamic configuration based upon the content and the characteristic data selected; and transmitting the dynamically generated literature through a multimedia player.

The principles consistent with some embodiments of the invention further relate generally to methods and systems for optimizing a rich presentation of a purchase or potential purchase. In systems consistent with features of some of embodiments of the present invention, users may create custom content representing a product or service available for purchase or reservation. By utilizing a graphic editor, the user may create content. Using a multimedia player program ADOBE FLASH™, the application can populate the content into a template page. The populated page is stored using FLASH format wherein the populated page can be viewed using the multimedia player.

Upon receipt of information related to a purchase or potential purchase (reservation), a record is stored at a central server with information of the purchase or potential purchase and, using a software application as discussed herein, an email is sent to the consumer including a URL. Upon receiving the mailing, the recipients, or consumers, follow directions on how to access their literature, or electronic book, included in the mailing using additional tools located on a network. Upon access of the content though a multimedia player, a dynamic configuration is built and the information on the recipient's purchase or potential purchase including selected content that will be displayed and template pages including formatting for the selected content is organized and determined. The consumer's actions performed after receipt of the content may be stored in the system for further use. For example, if the consumer participates in an outdoor activity, this information may be stored in a database as a characteristic associated with the consumer and considered when selecting content for a future purchase or reservation.

For exemplary purposes, the content may be described with respect to vacation packages. However, it may be appreciated by one of ordinary skill in the art that the principles consistent with some embodiments of the present invention may be implemented with any type of marketing scheme.

### System Architecture

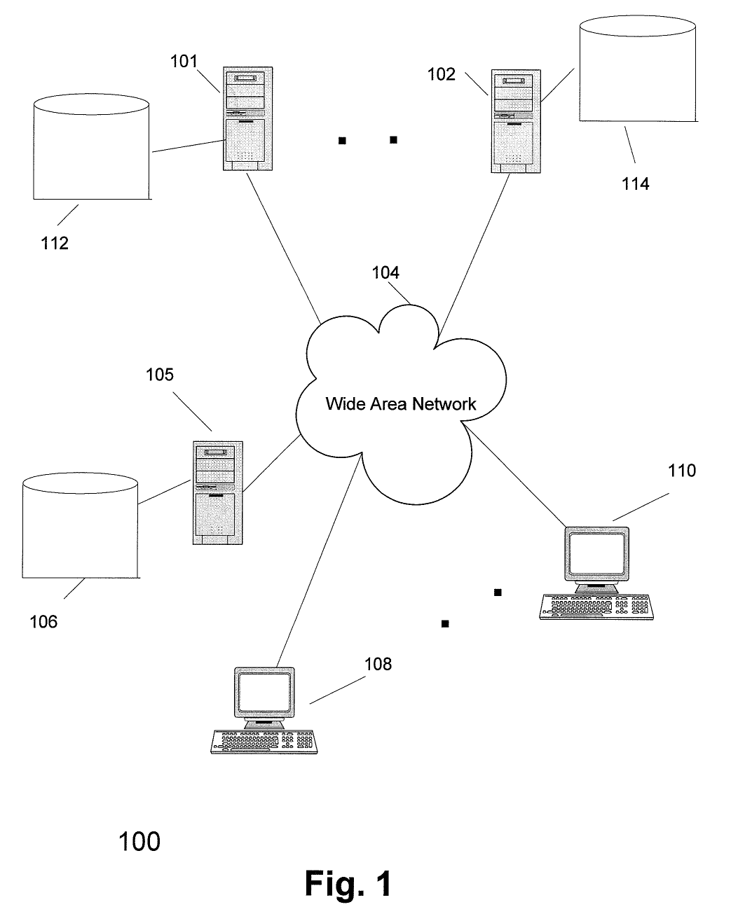

FIG. 1 is an exemplary diagram of a system environment 100 for implementing the principles consistent with some embodiments of the invention. The components of system environment 100 can be implemented through any suitable combinations of hardware, software, and/or firmware. As shown in FIG. 1, system 100 includes a plurality of computing devices 101, 102 communicating with server 105 via network 104. Further, while only two computing devices 101,102 are depicted in FIG. 1, it may be appreciated by one of ordinary skill in the art that more devices may operate within the system environment. Network 104 may be implemented as the Internet. It may further be appreciated that alternatively, network 104 may be implemented as any local or wide area network, either public or private. It may further be appreciated that there may be additional networks operating in environment 104 wherein additional devices may interact with server 105.

System environment 100 further includes a plurality of computing 108, 110 communicating with server 105 via network 104. While only two computing devices 108, 110 are depicted in FIG. 1, it may be appreciated by one of ordinary skill in the art that more computing devices may operate within the system environment 100.

System environment 100 includes server 105 and database 106. Database 106 may be communicably linked to server 105. Server 105 may store, access, modify, etc. data stored in database 106. Data relating to product(s) and/or services(s) purchased by a consumer may be transmitted from computing devices 101. 102 to server 105 for storage and processing in database 106. Further, database 106 may store information related to products and services offered for sale through computing devices 101, 102. Information related to products and services offered for sale may include template pages associated with each product and/or service offered for sale, identifying information of each product and/or service offered for sale, content associated with the products and services offered for sale, etc. Further databases 112, 114 may store data relating to purchases or reservations made by consumers as noted above. Information related to products and services offered for sale through computing devices 101, 102 may be stored during the registration process between computing devices 101, 102 as noted above. Still further, database 106 may store identifying information related to consumers, including a consumer identification number, name, address, e-mail address, gender, characteristics as discussed herein, etc.

Databases 112, 114 may be communicably linked to computing devices 101, 102. Computing devices 101, 102 may store and access data stored in databases 112, 114, respectively. Computing devices 101, 102 may be servers operating on network 104 and may be operated by a hotel, a resort, a golf course, or any type of organization selling a product or a service. Databases 112. 114 may store information related to the organization's products and/or services. Further databases 112, 114 may store data relating to purchases or reservations made by consumers as noted above. It may be appreciated by one skilled in the art that databases 112, 114 may be directly communicably linked to computing devices 101, 102, or may be communicably linked to computing devices 101, 102 through network 104.

Computing devices 101, 102 may be implemented as a server that are configured to run an inventory management system capable of facilitating purchases and/or reservations of products and/or services including storing inventory requests, purchases, and/or reservations, inventory change requests, and that is capable of operating, either directly or indirectly, on network 104. The inventory management system may be implemented as a Point of Sale System (for example, a computer operating at a spa and is used to store information related to reserved spa services), a Property Management System (for example, a computer operating at a hotel and is used to manage reservations at the hotel), a Central Reservation System (for example, a system that is used in operating a plurality of Property Management Systems within a single organization and is used to reserve inventory), a Global Distribution System (for example, Expedia), etc. Further, each of computing devices 101, 102 may be communicably linked to respective databases 112, 114. Each of the databases may, for example, store information relating to available services and/or products to be provided to a consumer, and further may store information relating to reservations made by a consumer for services and/or products.

Computing devices 108, 110 may be implemented as a personal computer, a workstation, or any personal handheld device, i.e., a Personal Digital Assistant (PDA), a cellular telephone, or any other device that is capable of operating, either directly or indirectly, on network 105 and is capable of operating a multimedia player as discussed herein. Computing devices may be configured to communicate with computing devices 101, 102 and server 105. Computing devices 108, 110 may be operated by consumers seeking to obtain services provided by the operators of computing devices 101, 102.

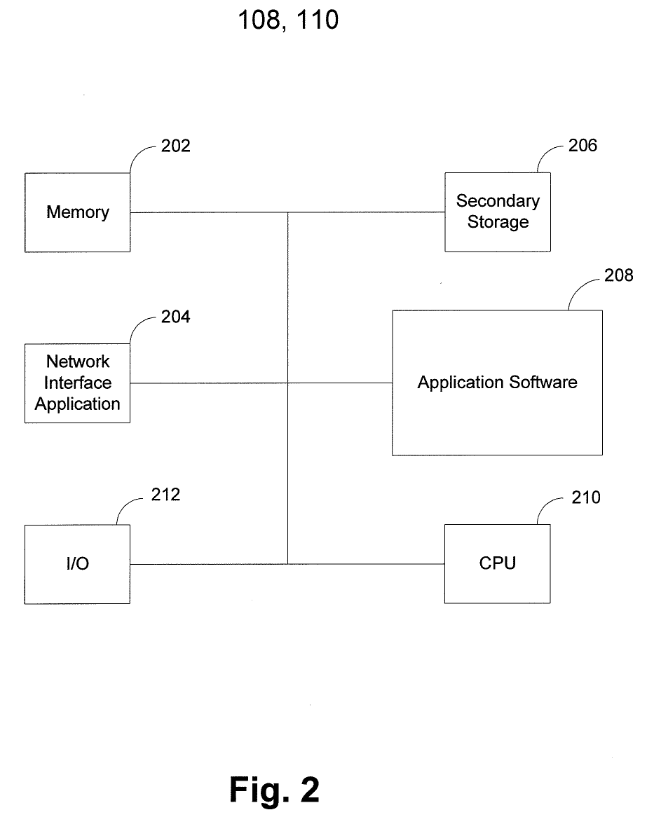

FIG. 2 depicts an exemplary block diagram of computing devices 108, 110 that may be implemented in system environment 100, consistent with the principles of some embodiments of the present invention. As shown in FIG. 2, computing devices 108, 110 include memory 202, network interface application 204, secondary storage 206, application software 208, central processing unit (CPU) 210, and input/output devices 212. Network interface 204 may be implemented as any conventional browser application to facilitate interaction with applications on server 105 and computing devices 101, 102 on network 104. Input/output devices 212 may include, for example, a keyboard, a mouse, a video cam, a display, a storage device, and/or a printer. Computing devices 108, 110 may be communicably linked with server computer 105 and computing devices 101, 102 using application software 208.

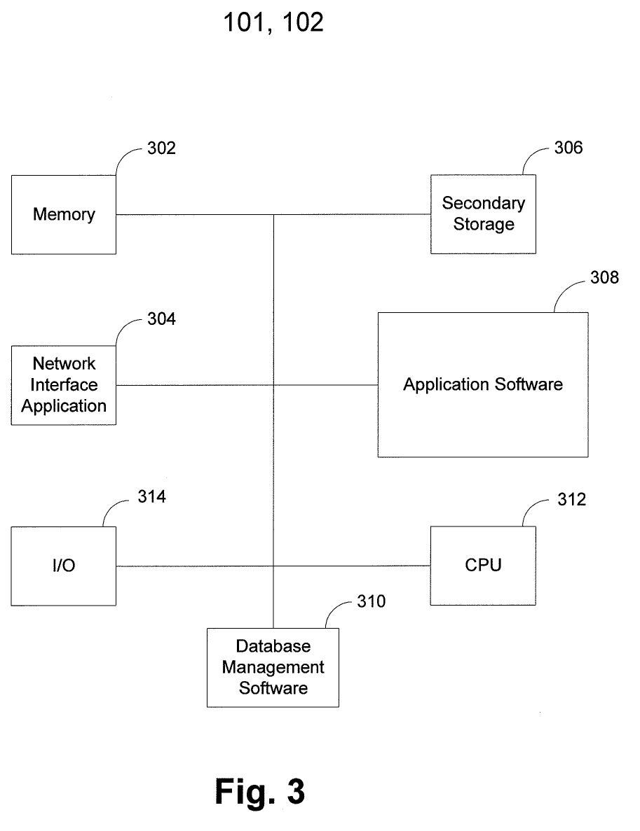

FIG. 3 depicts an exemplary block diagram of computing devices 101, 102 that may be implemented in system environment 100, consistent with the principles of some embodiments of the present invention. As shown in FIG. 3, computing devices 101, 102 include memory 302, network interface application 304, secondary storage 306, application software 308, database management application 310, central processing unit (CPU) 312, and input/output devices 314. Network interface 304 may be implemented as any conventional browser application to facilitate interaction with applications on server 105 and computing devices 108, 110 on network 104. Input/output devices 314 may include, for example, a keyboard, a mouse, a video cam, a display, a storage device, and/or a printer. Computing devices 101, 102 may be communicably linked with server computer 105 and computing devices 108, 110 using application software 208.

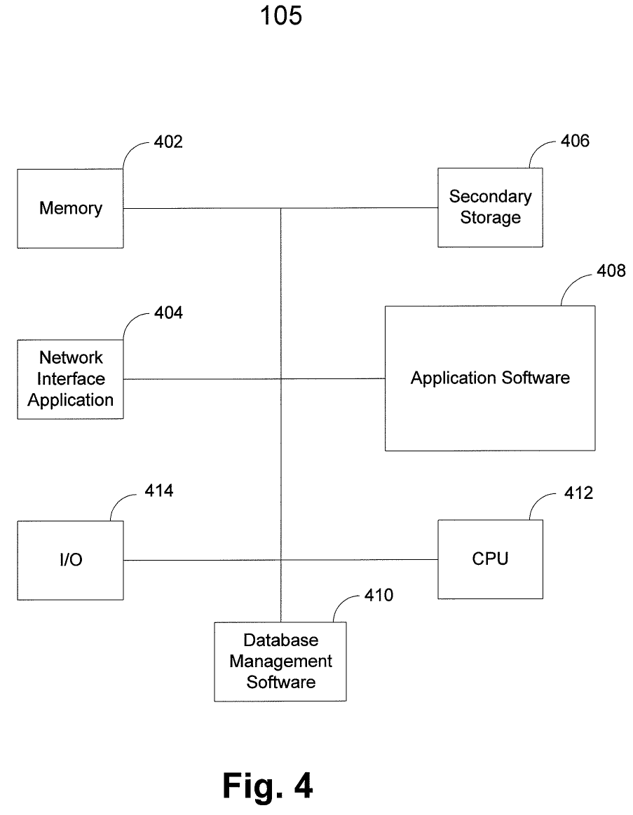

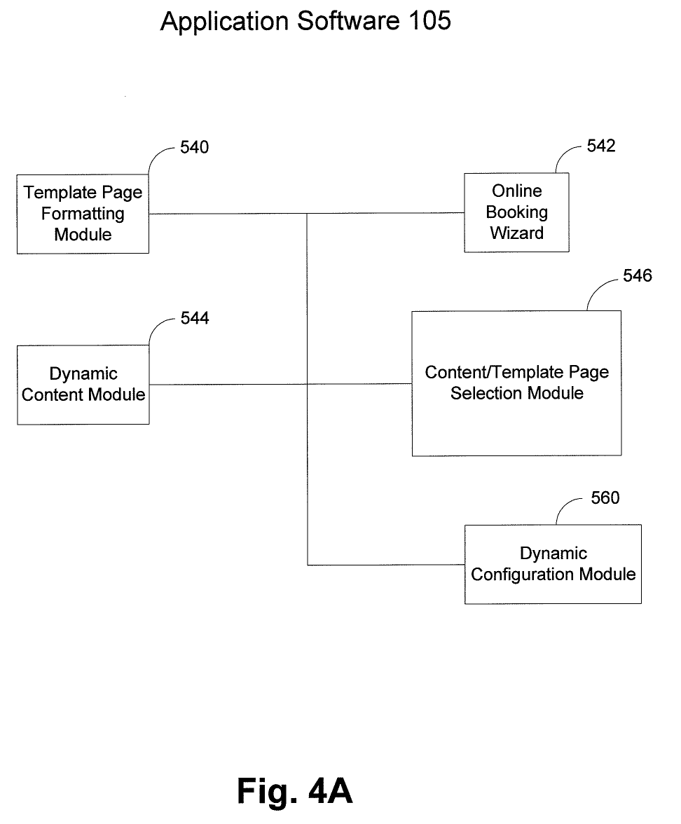

FIG. 4 depicts an exemplary block diagram of server 105 that may be implemented in system environment 100, consistent with the principles of some embodiments of the present invention. As shown in FIG. 4, server 105 includes memory 402, network interface application 404, secondary storage 406, application software 408, database management application 410, central processing unit (CPU) 412, and input/output devices 414. Network interface 404 may be implemented as any conventional browser application to facilitate interaction with applications on computing devices 101, 102 and computing devices 108, 110 on network 104. Input/output devices 414 may include, for example, a keyboard, a mouse, a video cam, a display, a storage device, and/or a printer. Server 105 may be communicably linked with computing devices 101, 102 and computing devices 108, 110 using application software 208.

Server 105 includes application software 408 that is used to generate information or an electronic book that a consumer who made a purchase or reservation may view. The electronic book may appear to the consumer as an electronic brochure or pamphlet that includes a number of pages. The electronic book may be dynamically created based on the information associated with the purchase or reservation. Further, the electronic literature may include selectable features. These selectable features, when selected by a consumer, may provide additional information relating to the purchase or reservation, opportunities for the consumer to make additional purchases or reservations, opportunities for the consumer to provide comments regarding the purchase or reservation, etc.

FIG. 4A depicts components included in application software at server 105. Application software includes template page formatting module 540 for formatting template pages, online booking wizard 542 as discussed below, dynamic content module 544 for generating content, content/template page selection module 546 for selecting content and template pages, and dynamic configuration module 560 for generating the dynamic configuration module as discussed herein.

### Template Page Formatting Tool Module 540

The template page formatting tool module allows a user to create a layout of template pages for use in the electronic book. A template page may be created for each product and/or service that is offered for sale. Once the template page is created, the template page is stored in database 106 and is associated with identifying information identifying the product or service to which is corresponds.

The tool provides a “page layout” mode for creating any style of format including images (i.e., gif and jpeg format, bitmap, etc.), moving images (i.e., .wav format, MPEG, etc.) text, etc. Using the tool, a user may create a template page indicating where all of the graphic elements (images, moving images, text, etc.) may be placed. The tool also includes a “view page” mode allowing for the precise placement of such content, and a “preview page” mode that allows for the previewing of how the layout of the actual page in the electronic book will look when it is generated. The predictive nature is to give the user an easy to use/intuitive tool (much like Microsoft Word® is to creating letters) to a novice user for the creation the pages in the electronic book.

The template page may further be associated with priority information to indicate in what order the template page may appear, with respect to other template pages, in the electronic book. For example, a template page associated with a hotel room reservation may have priority number 1; a template page associated with a dinner reservation may have a priority number 3, etc.

All of the template pages and their associated priority information may be stored in database 106.

### Dynamic Content Module 544

The dynamic content module allows the user to input content that may be utilized in creating the electronic book. Content may be, for example, still images, moving images, text, selectable content including links to other web pages and/or web sites, etc. Content may, for example, include information that relates to product(s) and/or service(s) available for purchase or reservation. For example, if the user's organization was a hotel, one piece of content may include the hotel's logo. Another type of content may include a still or moving picture of the product or service offered for sale or reservation. Additionally, content may include text that the user may input to relay some piece of information to a consumer. For example, the text may advise the consumer of some particular amenities that the hotel provides.

Content may additionally be static or dynamic. For example, static content is content that may be automatically included in the template page and is sent to all recipients of the template page. Examples of static content include, for example source information such as logos, contact information, generic images relating to the product or service, such as a picture of the hotel, etc. However, dynamic content may only be sent depending upon whether the consumer satisfies certain conditions or characteristics, set by the user. For example, the hotel may have a golf promotion where the consumer may pay one flat fee for the green fees, clubs, and cart. This promotion may only be sent to those consumers that play golf. As such, this piece of content may be created as a dynamic component whereby, only those consumers who have made a reservation for golf, or consumers who, based on their identifying information or characteristic, may be interested in playing golf, may receive this content in their electronic book. Both static and dynamic content are dynamic components that are used to create the electronic book. Alternatively, only static content may be used to generate the electronic book.

The user, operating server 105, or accessing server 105 through computing devices 101, 102, may upload content for use in the electronic book. In addition, the user may provide information identifying the corresponding product or service to which the content should be associated with. Further, the user may identify characteristics of a potential consumer that the content should be presented to. For example, an image of hotel room “A” with flowers in the image it may be stored with characteristic information including “Hotel room ‘A’” and “female”. The content and the characteristic data may be stored in database 106. Further, an image of hotel room “A” with a TV playing football may be stored with characteristic information including “Hotel room ‘A’” and “adult male”. Still further, an image with hotel room “A” without any additional features in the image may be stored with characteristic information including “Hotel room ‘A’”. Further, this image may have a characteristic defining this image as a default image, wherein, if there is no specific identifying information of a consumer, the default image may be selected for use in the electronic book.

Still further, the content may be selectable. The content may include a link to a URL such that, when selecting using a point device, i.e., a mouse, selection opens a browser and accesses the URL associated with the selectable content. The consumer is then capable of viewing additional information related to the purchase or reservation which is the subject of the electronic book. The selectable content may direct the consumer to a URL that provides additional information regarding the purchase or reservation that the consumer has already made. Alternatively, the content may direct the consumer to information regarding additional products or services the consumer may be interested in based on characteristics stored in database 106.

All of the content included may have priority associated therewith. No one piece of content may have the same priority as another content. Priority information is associated and stored in database 106.

### System Flow

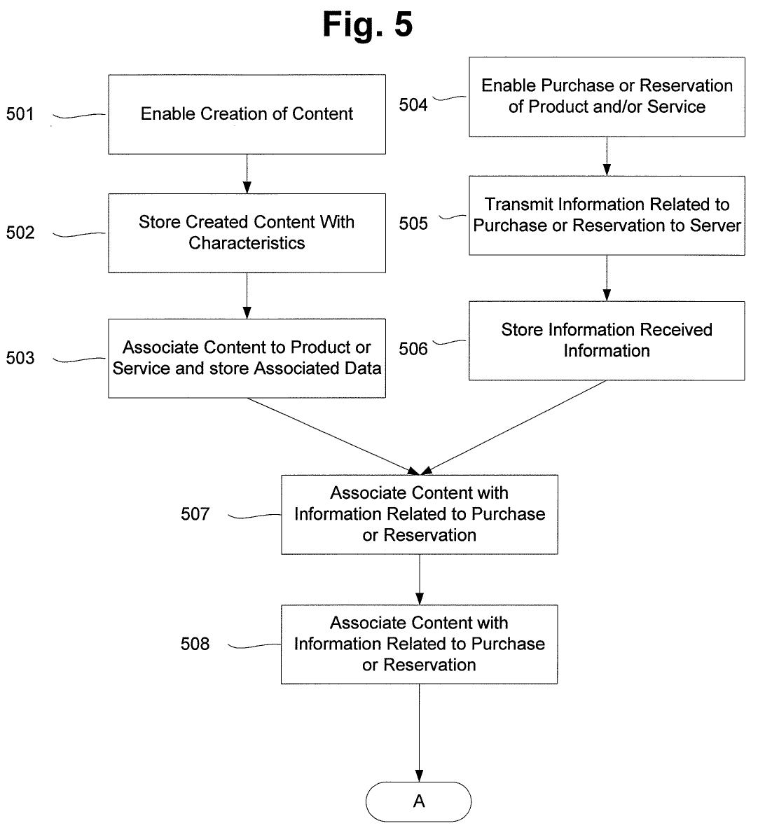

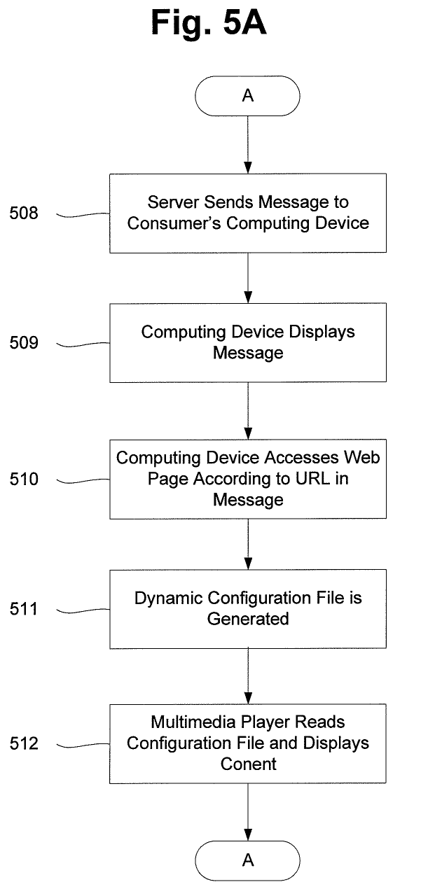

FIG. 5 depicts an exemplary flowchart that may be implemented in system environment 100, consistent with the principles of some embodiments of the present invention. At step 501, content may be generated using a graphic editor. It may be appreciated that the graphic editor program may reside on server 105, accessible by computing devices 101, 102 through network 104. Alternatively, the graphic editor may reside at computing devices 101, 102, wherein, upon completion of the content, the content may be transmitted to server 105 for storage in database 106. The content may be in the form of still images, moving images, text, etc., may be static or dynamic, and/or may be selectable. The content further may be related to the purchase of the consumer as discussed above with regard to the dynamic content module.

At step 502, the graphics created are stored in a rich media format in database 106. At step 503, all the content submitted is associated to one or more characteristics that can be associated to a profile or inventory a third party system, i.e., computing devices 101, 102, offers. For example, server 105 may be communicably linked to databases 112, 114, in order to access information related to services and/or products that may be available to consumers. For example, the generated content may be a photograph of a person using a product that is available for purchase. The content may be associated with the product information that is stored at database 112.

At step 504, a consumer, at computing device 108 or 110 makes a purchase or potential purchase (i.e., a reservation by reserving a product or service) while accessing computing device 101 or 102. Information relating to the purchase or reservation is stored in respective database 112 or 114. This information may include the consumer's name, a customer identification number, customer's gender, guest identifying information, children identification information, address, e-mail address, identifying information regarding the product or service purchased or reserved, date of pick-up of product, dates use of the service, date of reservation of room(s) in a hotel, consumer's hobbies, consumer's favorite activities, etc.

At step 505, the computing device 101 or 102 that received the purchase or reservation, utilizes network 104 to send information about the purchase or reservation by the consumer to server 105. This information about the purchase or reservation may be transmiftted to server 105 via, for example, Webservices, XML messaging, automated flat file uploads done through a communicable connection, manual flat file uploads done through a communicable connection, or any other known format, or any other known method as would be appreciated by one skilled in the art through network 104. It may be appreciated that the information transfer may be accomplished through a secure connection.

At step 506, the server 105 parses the received information to extract information identifying the customer, i.e., name(s) of person who made the reservation, date(s) of use, type of product or service purchased or reserved, etc. Further, server 105 analyzes the parsed information to extract characteristic information about the consumer and the purchase or reservation from the received information. The extracted characteristic information is associated with the consumer identifying information and is stored in database 106. It may be appreciated by one skilled in the art that the characteristic information may be stored in database 106 for use with regard to future purchases or reservations by the consumer. For example, if, during a first reservation, the extracted information reveals the consumer enjoys outdoor activities, this information may be stored as characteristic data and utilized in a future purchase made by the consumer. Alternatively, upon the purchase or reservation of a product or service, the consumer may be asked to complete a survey including a plurality of process-based questions. The answers provided by the consumer may be stored in database 106 as characteristic information and utilized in selecting content for display in an electronic book in relation to a present or future purchase.

Further server 105 stores identifying information related to the purchase or reservation in a queue to send out a message to the consumer.

At step 507, server 105 identifies the template page(s) that are associated with each of the products and/or services purchased or reserved. Server 105 then identifies all of the content associated with the product and/or service purchased and/or reserved and selects content associated with the product or service that is purchased or reserved based on the extracted characteristic information of the consumer. This is done by server 105 comparing the extracted characteristic information of the consumer with the characteristic information associated with the content associated with the product and/or service purchased or reserved. Server 105 then prioritizes the selected content based on previously stored priority information associated with the content. If there are only two areas allotted for content on the page layout, then the content with the top two priorities will be included in the electronic book. This may be completed by the content/template page selection module 546.

For example, if the consumer is female and reserved hotel room A, the server may select content including the image of the hotel room A with the flowers based on the characteristic information. Alternatively, if the characteristic information does not match any of the characteristic information associated with the content, a default image associated with hotel room A may be selected and stored.

Server 105 then combines the extracted information from purchase or reservation information at step 504 and the selected content. The combination is stored in a new record in database 106 including the product or service that is associated with the purchase or reservation from step 504, the customer identification number, and the content that is associated with the product or service that is purchased or reserved from step 503.

At step 508, server 105 sends a message based on the purchase or reservation stored in the queue to the consumer containing information on to how to retrieve the electronic book which is information related to the purchase or reservation. The message may be sent within a predetermined time of being stored in the queue. For example, the message may be sent one minute from the time the purchase information was stored in the queue. Alternatively, the message may be sent two hours from the time the purchase or reservation was stored in the queue in order to permit additional purchase or reservation information to be received at server 105.

The message may be sent in the form of an e-mail communication, SMS message, or any other type of electronic message communication system, to the consumer. The message to the consumer may include a URL wherein the consumer may access information relating to the purchase or potential purchase. The message may further include identifying information related to the purchase or reservation, i.e., a customer identification number.

At step 509, the consumer's computing device displays the message including the URL included in the message sent at step 509. At step 510, upon selection of the URL by the consumer, the consumer's computing device launches network interface application 204 (browser) and establishes communication with server 105.

At step 511, server 105 receives a request from consumer's computing device 108 or 110, for access to URL indicating a desire of the consumer to access an electronic book including content to be presented. The request includes the identifying information related to the purchase or reservation, i.e., the customer identification number.

Server 105 accesses database 106 to retrieve the data stored at step 507 in accordance with the received identifying information and selects the template page associated with each of the products and/or services stored in the record. Server 105 creates a dynamic configuration file ordering the template pages and organizing the content associated with the product or service purchased or reserved in step 507 for display in a multimedia player. The template pages may be ordered based on the predefined priority information that is associated with the template page. In creating the dynamic configuration file, the server 105, through dynamic configuration module 560, stores information related to the order in which the template pages are to be displayed, identifying information identifying each of the template pages to be included, and the customer identification number. Alternatively, in addition to the above information, information identifying the content to be displayed may be included in the configuration file. The server 105 then transmits the configuration file to the consumer's computing device 108, 110.

At step 512 a multimedia player is launched by the web based application at step 510 and reads the configuration created at step 511. The multimedia player opens the configuration file and accesses the template pages identified in the configuration file from server 105 and the content associated with the customer identification number or the content identified in the dynamic configuration file. The Flash application at the computing device 108, 110, then populates the template pages with the associated content. An electronic book is created by formatting the populated template pages then retrieves the content from server 105. The multimedia player running on device 204 displays the content in the form of an electronic book retrieved in step 512. The consumer may view the electronic book to view the purchased and/or reserved product(s) and/or service(s), navigate through the electronic book, and access the selectable elements in order to obtain additional information regarding the purchase and/or reservation and further, may purchase additional products and/or services using the selectable content.

If the consumer makes additional purchases and/or reservations, the information may be transmitted to server 105 and the system flow may be repeated as shown in FIGS. 5 and 5A in order to provide an updated electronic book.

### Dynamic Electronic Book

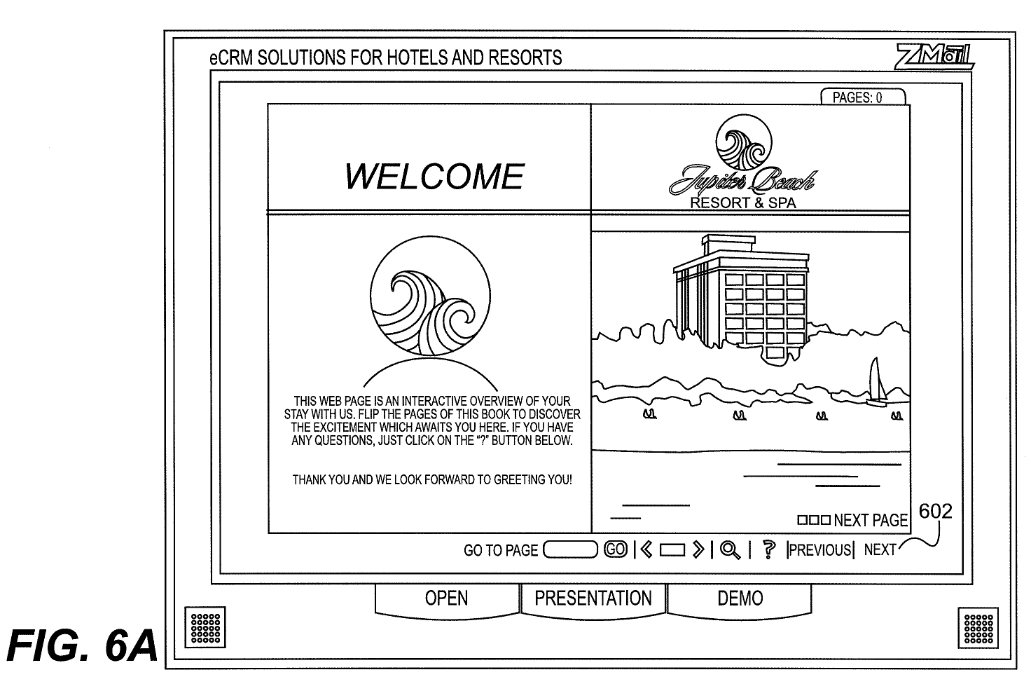

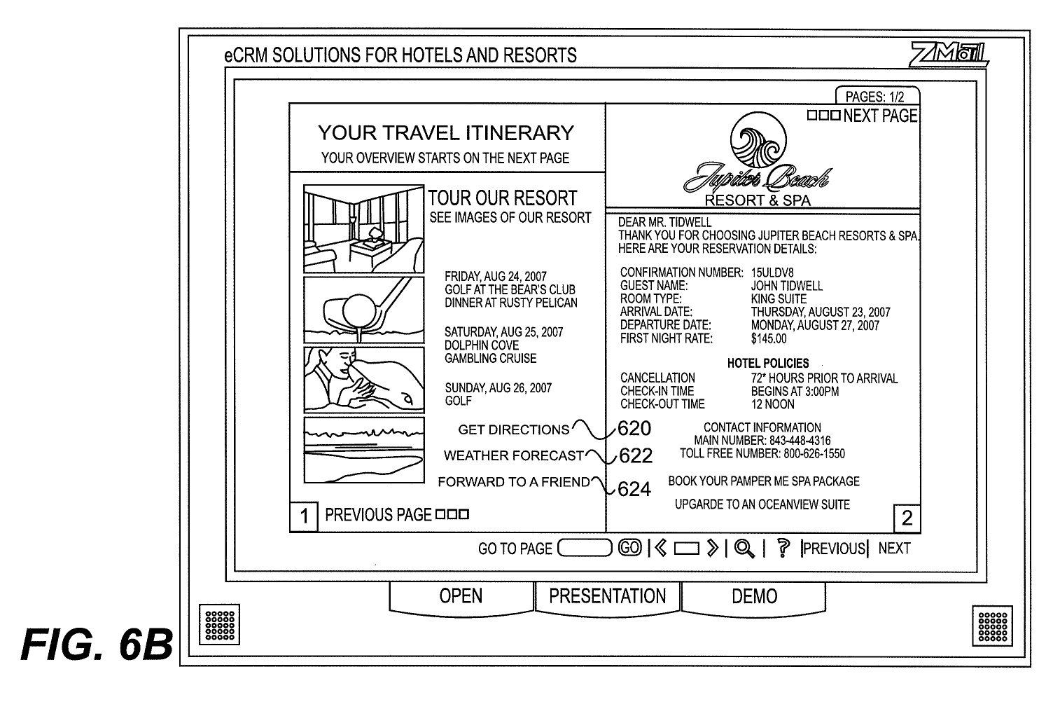

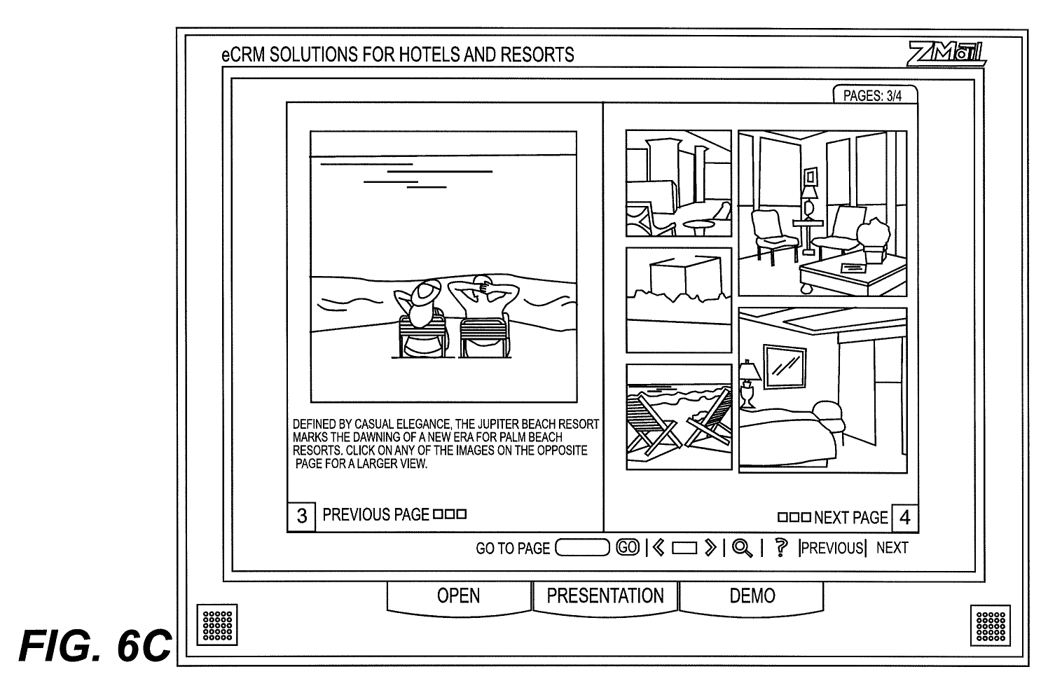

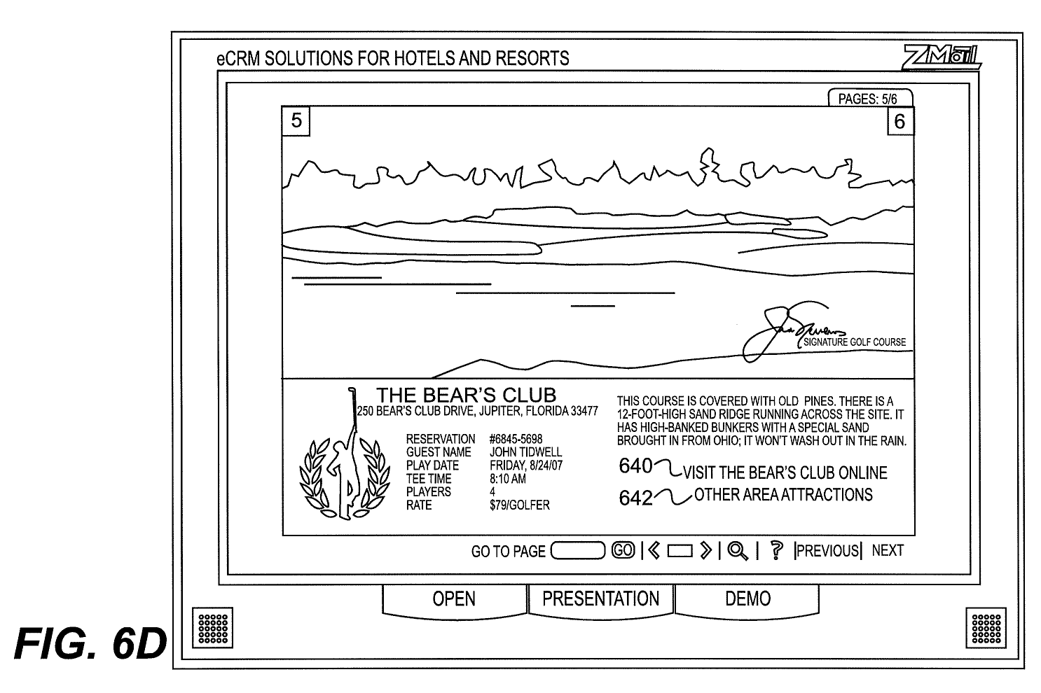

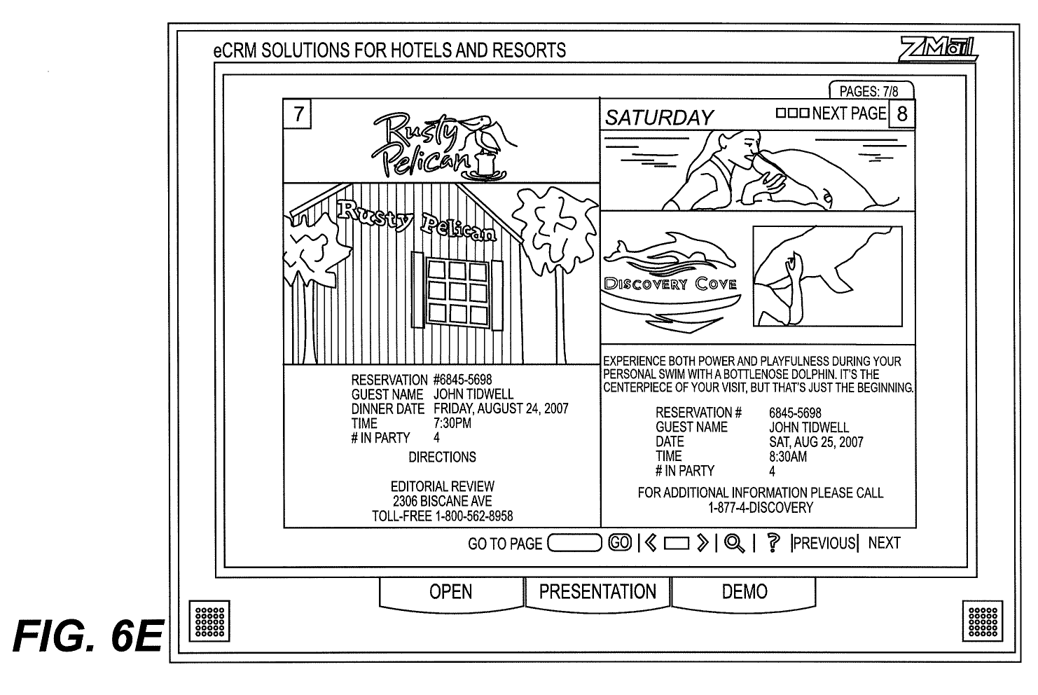

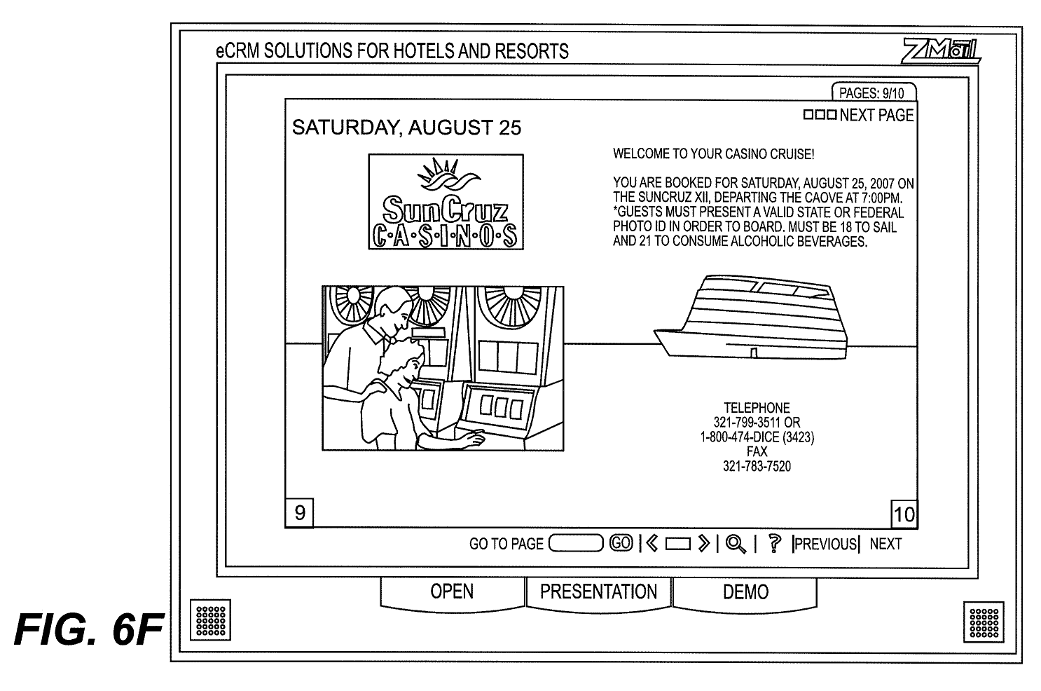

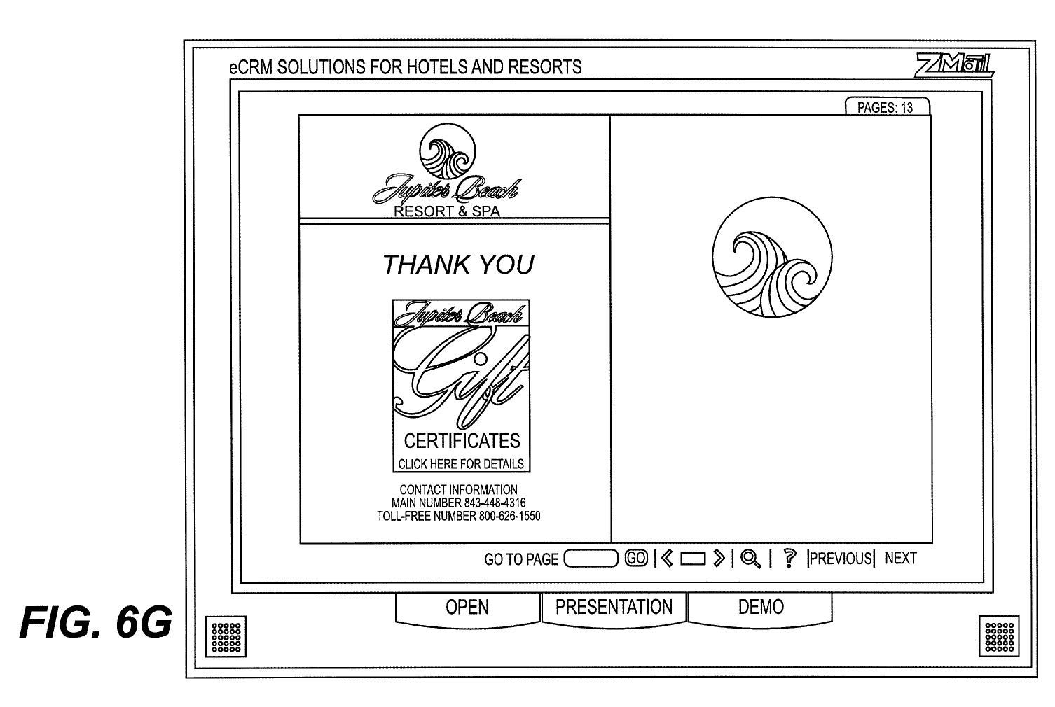

FIGS. 6A-6H depict exemplary screen shots of electronic information or electronic book that may be presented to a consumer upon accessing the URL at server 105. In this example, the consumer has made a reservation at Jupiter Beach Resort and Spa. As can be seen in FIG. 6A, the consumer is presented with a welcome page advising the consumer that the information in the book is related to the purchased or reserved product or service. Using the selectable commands 602, the consumer may navigate through the electronic book

FIG. 6B depicts an exemplary screen shot of pages 1 and 2 of the book. Page 1 depicts the consumer's travel itinerary. FIG. 6B depicts selectable element “Get Directions” 620, wherein, when selected, the consumer may be provided directions to the Resort. Alternatively, the consumer may be directed to a web page operating on computing devices 101, 102 that includes directions to the Resort. Selectable element “Weather Forecast” 622 provides the consumer information relating to the weather forecast at the Resort. Alternatively the application may direct consumer to a web page operating on computing devices 101, 102, or operating on a separate computing device that hosts a weather application that provides information about the weather forecast at the resort. Selectable element “Forward to a Friend” 624, when selected, initiates the consumer's e-mail program operating at the consumer's computing device, and permits the consumer to send an e-mail to a friend forwarding the URL of the electronic book, wherein the friend may access the electronic book.

Page 2 depicts a message to the consumer providing information to the consumer regarding the reservation. Additionally, selectable element “Book your Pamper Me Spa Package” 626 appears on page 2. Upon selection of this selectable element, the consumer may be directed to a web page operating on computing devices 101, 102 wherein the consumer may purchase or reserve services or products related to the Resort's spa. Upon further reservation between the consumer at the consumer's computing device 108 or 110 and computing device 101 or 102, the additional reservation may be transmitted to server 105, wherein the electronic book may be dynamically re-created with the updated reservation information and the previous reservation information.

Page 2 further includes selectable element “Upgrade to an OceanView Suite” 628. Upon selection, the consumer may be directed to a web page on computing device 101 or 102 in order to view information related to the OceanView suite at the resort and, further, may update the reservation to reflect the upgraded room. Upon upgrading the reservation, information regarding the upgrade may be transmitted to server 105, wherein the electronic book may be dynamically re-created with the updated reservation information and the previous reservation information.

FIG. 6C depicts pages 3 and 4 of the electronic book including images of the resort and information for the consumer.

FIG. 6D includes pages 5 and 6 of the electronic book. Page 5 of the electronic book provides information related to golf reservations made by the consumer at The Bear's Club. This reservation may have been made at a separate computing device operated by The Bear's Club. Page 6 includes selectable element “Visit the Bears Club Online” 640. Upon selection, the consumer may be directed to a web page on a computing device operated by The Bears Club. Page 6 further includes selectable element “Other Area Attractions” 642 wherein, upon selection, the consumer may be directed to a web page operating on the computing device operated by The Bears Club, or a web page operated by a different organization, wherein the consumer may obtain information related to other area attractions.

FIG. 6E includes pages 7 and 8 of the electronic book. Page 7 of the electronic book provides information related to dinner reservations made by the consumer at The Rusty Pelican. This reservation may have been made at a separate computing device operated by The Rusty Pelican. Additional selectable elements are depicted wherein, upon selection, the consumer may obtain information related to directions to the restaurant and an editorial review of the restaurant.

Page 8 of the electronic book provides information related to reservations made at Discovery Cove for swimming with dolphins. This reservation may have been made at a separate computing device operated by Discovery Cove.

FIG. 6F includes pages 9 and 10 of the electronic book. Page 10 of the electronic book provides information related to reservations made by the consumer for a Casino Cruise at SunCruz Casinos. This reservation may have been made at a separate computing device operated by SunCruz Casinos.

### On-Line Booking Wizard Module 542

As discussed above, a consumer may make reservations with different organizations by accessing each of the organization's computing devices and reservation applications separately. Alternatively, the consumer may access an on-line booking wizard module that facilitates multiple in one session. For example, the consumer may wish to make a reservation for a particular hotel for a particular time period, a round of golf for a particular time period, and theater tickets for a particular show at a particular time. Using the on-line booking wizard module, the consumer may schedule each of these events at server 105 in one session. Upon accessing the on-line booking wizard module, the consumer may be prompted to enter information related to a particular hotel for a particular time period, a round of golf for a particular time period, and theater tickets for a particular show at a particular time. Server 105 may access hotel server for example, computing device 101, and book a reservation in accordance with the terms provided by the consumer.

Further, the consumer may request a golf reservation. Server 105 may access Tlinks server operating in system environment 100 (not shown) and schedule the golf round in accordance with the information provided by the consumer. Finally, the consumer may request theater tickets for a particular show on a particular day. Server 105 may access ticketmaster server operating in system environment 100 (not shown) and purchase theater tickets in accordance with the information provided by the consumer. The consumer may additionally be required to provide billing information whereby bank server operating in system environment 100 (not shown) may be accessed to facilitate the booking of the reservation.

It may be appreciated that the on-line booking wizard module may be located at server 105, computing devices 101, 102, or at another computing device communicably linked to network 104 and server 105.

Modifications and adaptations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for generating a dynamic electronic book for display in a multimedia player application, comprising:
receiving information about a purchase by a consumer from a first remote computing device;
accessing content associated with the received information;
extracting characteristic data associated with the purchase from the received data;
selecting content to be included in the electronic book from the accessed content based on the characteristic data;
generating a dynamic configuration file including information identifying the selected content, information identifying at least one template page, and at least a portion of the received information;
transmitting the generated dynamic configuration file to a remote device;
receiving a request for content and the at least one template page identified in the dynamic configuration file;
transmitting the content and the at least one template page in response to the request for display in the electronic book.

2. The method of claim 1, wherein characteristic data includes information about the consumer.

3. The method of claim 2, wherein the information associated with the consumer is acquired using plurality of process-based questions posed based on a survey presented to the consumer.

4. The method of claim 2, wherein the information associated with the consumer is further enhanced through data mining.

5. The method of claim 2, wherein the dynamic configuration establishes the order of the template pages for display.

6. The method of claim 1, wherein the electronic book includes selectable elements.

7. The method of claim 1, wherein the electronic book is generated based on the configuration file and displayed at a second remote computing device.

8. An apparatus for generating a dynamic electronic book for display in a multimedia player application, comprising:
a memory, storing a set of instructions; and
a processor, configured to execute the instructions stored in memory, to
receive information about a purchase by a consumer from a first remote computing device;
access content associated with the received information;
extract characteristic data associated with the purchase from the received data;
select content to be included in the electronic book from the accessed content based on the characteristic data;
generate a dynamic configuration file including information identifying the selected content, information identifying at least one template page, and at least a portion of the received information;
transmit the generated dynamic configuration file to a remote device;
receive a request for content and the at least one template page identified in the dynamic configuration file; and
transmit the content and the at least one template page in response to the request for display in the electronic book.

9. The apparatus of claim 8, wherein characteristic data includes information about the consumer.

10. The apparatus of claim 9, wherein the information associated with the consumer is acquired using plurality of process-based questions posed based on a survey presented to the consumer.

11. The apparatus of claim 9, wherein the information associated with the consumer is further enhanced through data mining.

12. The apparatus of claim 9, wherein the dynamic configuration establishes the order of the template pages for display.

13. The apparatus of claim 8, wherein the electronic book includes selectable elements.

14. The apparatus of claim 8, wherein the electronic book is generated based on the configuration file and displayed at a second remote computing device.

15. A computer-readable medium, storing instructions, executed by a processor, to perform a method for generating a dynamic electronic book for display in a multimedia player application, the method comprising:
receiving information about a purchase by a consumer from a first remote computing device;
accessing content associated with the received information;
extracting characteristic data associated with the purchase from the received data;
selecting content to be included in the electronic book from the accessed content based on the characteristic data;
generating a dynamic configuration file including information identifying the selected content, information identifying at least one template page, and at least a portion of the received information;
transmitting the generated dynamic configuration file to a remote device;
receiving a request for content and the at least one template page identified in the dynamic configuration file;
transmitting the content and the at least one template page in response to the request for display in the electronic book.

16. The computer-readable medium of claim 15, wherein characteristic data includes information about the consumer.

17. The computer-readable medium of claim 16, wherein the information associated with the consumer is acquired using plurality of process-based questions posed based on a survey presented to the consumer.

18. The computer-readable medium of claim 16, wherein the information associated with the consumer is further enhanced through data mining.

19. The computer-readable medium of claim 16, wherein the dynamic configuration establishes the order of the template pages for display.

20. The computer-readable medium of claim 15, wherein the electronic book includes selectable elements.

21. The computer-readable medium of claim 15, wherein the electronic book is generated based on the configuration file and displayed at a second remote computing device.
